(19) United States
(12) Patent Application Publication
(10) Pub. No.: US 2011/0190936 A1
(43) Pub. Date: Aug. 4, 2011

(54) Portable Power Tool

(75) Inventors: Thilo Koeder, Gerlingen (DE); Joachim Platzer, Remseck-Hochberg (DE); Ulli Hoffmann, Niefern-Oeschelbronn (DE); Jan Koegel, Mount Prospect, IL (US)

(73) Assignee: Robert Bosch GmbH, Stuttgart (DE)

(21) Appl. No.: 13/056,075

(22) PCT Filed: May 28, 2009
(86) PCT No.: PCT/EP2009/056518

§ 371 Date: Apr. 15, 2011

(30) Foreign Application Priority Data
Jul. 28, 2008 (DE) 102008040774.7

(51) Int. Cl. G06F 19/00

(52) U.S. Cl. 700/259; 700/245; 901/47

(57) ABSTRACT

The present invention relates to a portable power tool (1) comprising a sensor unit adapted to detect a working mark (17, 18) provided on a work piece to be processed using the portable power tool (1), said mark defining a target position of the portable power tool (1), and a control unit for determining a deviation of the actual position from the target position based on the signal output of the sensor unit, wherein a positioning unit is provided that is adapted to make an automatic correction of the portable power tool (1) from the actual position to the target position, and or a signal output unit is provided for issuing signals that represent the determined deviation to a user for the purposes of making manual corrections.

The present invention relates to a portable power tool and to a positioning method for said portable power tool.

These types of portable power tools are known in the prior art and can be, for example, a compass saw, a milling cutter, a drill, a staple gun or a spot welding device. Common to said portable power tools is that they are independent of a workpiece to be processed. To process the workpiece the portable power tool is positioned at the desired processing point and, where applicable, during the processing is displaced onto or at the side of the workpiece. In the case of punctiform processing, for example by a drill or a staple gun, the portable power tool is aligned once and is not moved during the processing of the workpiece. In contrast to this, in the case of a compass saw or milling cutter for example, the processing takes place during a displacement operation of the tool on the workpiece, which means that an operator continuously has to exercise great care and attention when carrying out the processing.

When such portable power tools are used, one or more marks are put on the workpiece in order to position the portable power tool for the processing. To this end, for example, a position at which a hole is to be drilled using the drill is indicated with a pencil or a marking tool and/or is marked with a center punch. For linear processing, as is carried out, for example, by the compass saw, a line along which the processing of the workpiece is to be carried out, is indicated or marked on the workpiece such that the portable power tool can be guided along said line.

As the portable power tools are usually guided or held freely, this type of positioning can easily result in a positioning of the portable power tool that deviates from the mark and, correspondingly, in an incorrect processing of the workpiece. It is true that this risk can be reduced by applying increased care and attention, but it can never be eliminated. In all cases increased care and attention results in greater expenditure of time.

Proceeding from this prior art, it is an object of the present invention to provide a portable power tool where the processing accuracy and speed are improved. A further object of the invention is to create a positioning method for portable power tools.

The first object is achieved in that the portable power tool is designed having a sensor unit which is realized in such a manner that said sensor unit is able to detect a working mark provided on a workpiece, said working mark defining a required position of the tool, and having a control unit, which determines a deviation of the actual position from the required position on the basis of the signal output of the sensor unit, wherein a positioning unit is provided which is realized in such a manner that said positioning unit performs an automatic correction of the portable power tool from the actual position to the required position, and/or a signal output unit is provided which outputs signals representing the determined deviation to a user for the purposes of the manual correction.

The second task is achieved by a positioning method for said tool where a working mark, provided on a workpiece to be processed with the aid of the portable power tool and defining a required position of the electric tool, is detected by the portable power tool, and a deviation of the actual position from the required position is determined on the basis of the required position detected by the portable power tool, an automatic correction of the actual position to the required position being performed by the portable power tool, and/or signals representing the determined deviation are output by the portable power tool to a user and the actual position is corrected by the user to the required position.

A basic concept of the invention is therefore to design the portable power tool such that it automatically detects the working mark and determines the deviation from the working mark. Said deviation can then be automatically compensated for by the positioning unit or can be displayed to the user such that said user is able to correct the deviation manually. Over and above this, it can be useful to combine the automatic positioning with the manual correction in order, for example in the case of processing using a compass saw, to compensate for a deviation from the working mark immediately on the one hand and on the other hand to display the deviation. This prevents the user, when continuing the processing, producing an even greater deviation from the working mark. This ensures that setting limits of the positioning unit, which can be of different sizes depending on the actual development of the portable power tool, are not reached because the user receives the additional feedback for the manual correction.

Depending on the processing, the working marks to be detected can mark either a processing point or a processing line, which does not affect the correction of the position.

The portable power tools can be realized with a sliding block by way of which they rest and are guided on the workpiece, thereby ensuring fixed support on the workpiece, on the one hand, and on the other hand making it easily possible to displace the portable power tool on the workpiece.

In the development of the invention, the sensor unit can include an optical recognition unit and the control unit can include a microcontroller. Consequently images can be recorded by the optical recognition unit of the portable power tool and the deviation can be calculated by way of the images recorded. A working mark applied to the workpiece can be detected by the image acquisition and processing. These types of image acquisition systems are already widely used in other areas of technology and can be provided at low expenditure. In particular, the optical recognition unit can be realized in such a manner that it records an image in a linear manner, and the control unit can be realized in such a manner that it determines the deviation on the basis of the individual lines. This type of line-based evaluation can be carried out in a particularly simple manner and requires only a small amount of computing power from the microcontroller. In particular, linear marks can be detected in a particularly simple manner in this way.

The optical recognition unit can also have an annular lens. On account of the usually short distance between the tool and the workpiece, this special type of lens can contribute to improved detection of the mark.

In an advantageous manner the sensor unit can be provided on the portable power tool so as to be removable, for example by means of a plug-in connection. Thus, it can be possible in a simple manner to exchange the same camera between different types of portable power tools if said portable power tools have a suitable plug-in connection. As this type of positioning is suitable in principle for different types of tools, the tools can be operated in each case, where required, with the same camera. In addition, in this way the camera can be removed from the portable power tool for easy cleaning or servicing, which will occasionally become necessary due to the processing predominantly being machining and due to the fact that chips created during said machining do fly around.

In a further development of the invention, the positioning unit can have an actuating drive and a corresponding controlling means for each independent positioning direction. To this end, it can be sufficient, for example when using a milling cutter, if positioning takes places exclusively in the direction transversely relative to the direction of milling. In the case of a drill, two-dimensional positioning is necessary for positioning the drill on the workpiece, which is why an actuating drive with controlling means is necessary here for each axis. In the case of a compass saw once again, positioning transversely relative to the mark first of all can be sufficient. On account of the directed processing by the compass saw on a front side of the saw blade, however, compass saw blades are nowadays frequently held on the compass saw so as to be rotatable such that this can represent a further positioning direction and whereby processing is possible also along curved marks. The actuating drives, in this case, are preferably realized as servomotors, step motors or piezo actuators, which are particularly suitable for accurate control.

In addition, the signal output unit can include visual signal output means. On account of the noise emission usually generated by the processing, the deviation can be displayed to the user visually in a manner that is reliable for the user. The visual signal output means preferably include LEDs or a display. The deviation can be definitively represented on the display, for example in the form of a target point and a graticule or in the form of arrows or bars that specify the direction and size of the deviation. LEDs can be provided, for example, in the positioning directions in order to indicate a deviation in each positioning direction. A further advantage of LEDs is the low power consumption that is significant, in particular, for cordless tools.

In a specific development of the invention, the control unit can be realized in such a manner that the positioning unit and processing by the power tool are controllable together. Automatic processing of the workpiece can be carried out in this way, the user simply being necessary for the positioning and, where applicable, fixing of the portable power tool. Thus, for example, once it has been positioned a drill can be controlled to drill a plurality of holes automatically into the workpiece corresponding to certain defaults, without the drill having to be repositioned for each hole. The automatic sawing out of holes using a compass saw is also possible in this way. In the case of the drill, along with the positioning on the workpiece, it is necessary to carry out positioning in the axis perpendicular to the workpiece in order to be able to drill the holes. This is made possible through the implementation of a further positioning direction in the positioning unit. Controlling the positioning unit and the processing together is particularly important for tools that only work in a punctiform manner. These include, for example, the staple gun and the spot welding device. However, even in the case of the drill, for example, targeted control of the drill is necessary, on the one hand, in order to minimize a possible risk of injury if the drill is not positioned on the workpiece, and on the other hand, to minimize noise by driving the drill in a targeted manner only where required and, in particular in cordless mode, to minimize power consumption. If applicable, such as for example in the case of a screw tap, precise directional control for the processing can be urgently necessary to carry out the processing correctly.

The portable power tool can also include an aiming device by means of which the region that is detectable by the sensor unit is markable on the workpiece. This can be realized, for example, in the form of an optical sighting device or in the manner of a template that is guided on the workpiece, the required position on the workpiece being detectable within said mark. The aiming device preferably includes at least one light element and the region in which the marking is detectable by the sensor unit is markable by means of radiated light from the light element. On account of the low power consumption, the light element can be realized in particular in the form of at least one LED. The marking with light, in this case, can consist, for example, of an illumination of the region of the workpiece that is detectable by the sensor unit. At the same time the illumination improves the detecting by the sensor unit, as inadequate illumination or a possible shadow formed by the portable power tool itself is compensated for. A mark in the form of a bright-line frame on the workpiece, in particular in an easily perceptible color, is also possible to mark the region on said workpiece.

In addition, the aiming device can be realized with a marking device for the marking of the preferred direction of displacement of the portable power tool. In a simple manner, this can be carried out, for example, by a specifically shaped mark for detecting the required position, if this is realized, for example, as a triangle, one corner of the triangle marking the preferred direction of displacement. This means that the user can concentrate fully on the operation of the portable power tool and he does not additionally have to observe the mark for the processing. This can be particularly helpful in the case of linear processing.

In another development of the invention, the portable power tool can have path detecting means for detecting a displacement of the portable power tool on the workpiece. This means that uniform processing of the workpiece at predetermined spacings along a line, for example, can be carried out without each processing position having to be marked individually on the workpiece. It is already sufficient if the line along which the uniform processing is to be effected, is marked, where applicable together with a start point. This can also simplify the marking of the tool in a considerable manner because in the case of non uniform processing, the user can decide autonomously on the processing when the displacement path covered is signaled to him.

A mechanical guide element can also be provided on the portable power tool in the contact region with the workpiece, said mechanical guide element being engageable in a groove or channel of the workpiece or being placeable on an edge of the workpiece. This means, for example, that processing can take place along an edge of the workpiece, which is very frequently necessary in practice, the edge not having to be extra marked and consequently representing a very precise mark. In the event of a compass saw, a type of fin can be provided at the back of the tool in the displacement direction for example, in order to improve lateral guiding. The fin can engage in the recess formed by the sawing and can prevent the portable power tool from moving to the side. This makes it possible to process the workpiece more rapidly and fewer corrections to the position are necessary. To this end, the mechanical guide element is preferably held so as to be countersinkable on the portable power tool by way of a resilient device. Thus, for example, the processing within a surface of the workpiece can be started with the compass saw, the fin being countersunk in the tool. As soon as a sufficiently large piece has been sawn, the fin can spring out of the tool and engage into the cut formed by the sawing. The mechanical guide element can also be detachably connected to the portable power tool, the guiding thereby being able to be adapted for the processing or defaults by the workpiece in dependence on the actual requirements. Thus, for example, wider cuts through the use of wider saw blades or wider milling cutters require wider guide elements so as to enable precise guiding, and vice versa. This can be achieved by exchanging the fin.

In the case of a particular embodiment, adhesive elements with rubber or friction linings are provided on the portable power tool in such a manner that they are moveable between a first position in which they do not abut against the workpiece, and a second position in which they do abut against the workpiece. Thus, for example, adhesive elements can be provided in the sliding block, being pushed out of the block for processing at a fixed position, and otherwise being countersunk in the block. This leads to a type of jacking-up of the portable power tool, as the contact with the workpiece is produced purely via the adhesive elements. The portable power tool can then be fixed to the workpiece through the pressing of the adhesive elements against the same. The adhesive elements, however, can also be held pivotably on the portable power tool such that they can be pivoted out of one position, in which they do not abut against the workpiece, into a position in which they do abut against the workpiece. This definitive development is exclusively dependent in this case on the type of tool and the type of workpiece.

In a specific development of the invention, the at least one adhesive element can include an electromagnetic element and the portable power tool can be pressable against the workpiece through the application of an electromagnetic field. If magnetic workpieces are processed with the portable power tool, a securing of the portable power tool to the workpiece can be achieved, for example, by applying an electromagnetic field with one electromagnet on the portable power tool or with smaller electromagnets on the adhesive elements. Since a force is exerted here by the magnets themselves, the user is relieved from the securing operation.

Another type of securing consists in that an intake device is provided on the portable power tool, by means of which intake device a negative pressure can be built-up in the contact region between the portable power tool and the workpiece. To this end, the intake device can have associated therewith an external vacuum pump for the generation of the negative pressure. Thus, for example, the negative pressure can be built-up in a region of the sliding block between the workpiece and the portable power tool, which is easily possible in particular in the case of smooth workpieces. The region of the negative pressure is preferably surrounded by a rubber seal such that the negative pressure can be maintained in a simple manner without the vacuum pump having to work continuously.

In a further development of the invention, the intake device can have a reverse operation by said device generating an overpressure. This means that an overpressure can be generated in a contact region between portable power tool and workpiece and the portable power tool can be displaced on the workpiece on a forming air cushion. This means that the sliding block experiences less resistance when sliding on the workpiece, further simplifying the processing of the workpiece.

In addition, the portable power tool can have rollers in the contact region with the workpiece. By way of the rollers, the tool can be displaced on the workpiece with a high degree of directional precision. To this end, the rollers are preferably produced from a rubber-type material, thereby increasing the adhesion of the rollers on the workpiece. In particular with smooth, for example metallic workpieces, this clearly increases the adhesion on the workpiece. The use of at least one roller as path detecting means for the displacement of the portable power tool is also conceivable.

The rollers can also be driveable via the control unit. Consequently, the portable power tool can be displaced on the workpiece through the driving of the rollers, which provides the processing of the workpiece with a further degree of freedom. The displacement of the tool is coordinated together with the processing by the control unit. To this end it can also be useful for the fixing of the tool on the workpiece, for example via the controlling of the electromagnets or the activating of the negative pressure generating means, to be coordinated with the displacement of the tool, such that the tool can perform the processing in a quasi autonomous manner. The direction of displacement of the tool can also be influenced by the rotating of the rollers such that almost any processing processes of the workpiece are possible.

Finally, an interface for data exchange can be provided on the portable power tool. Control instructions necessary in each case can be transmitted, for example from an external data processing device to the power tool via the interface, which means that a high level of flexibility is possible for the processing. It is also possible to transmit groups of control instructions combined together to form programs. Depending on the desired processing, only the program necessary in each case has to be transmitted to the portable power tool. In principle it is also possible to store a plurality of programs in the portable power tool, however the storage possibilities are usually limited and the operator interface is usually small corresponding to the size of the portable power tool. Consequently, it is true, in principle, that it is also possible to select or even create programs on the portable power tool itself, however this cannot be executed in a sufficiently easy-to-use manner. Consequently the programs are preferably created and selected by the external data processing device which means that only the processing has to be carried out with the portable power tool. Moreover, further information, such as, for example, path lengths covered during the processing, service information on the state of the tool or, where applicable, also current operating states can be interrogated via the interface. In this case, how the interface is physically shaped is insignificant, however a wireless interface increases the security of the data transmission on account of the type of processing carried out with the portable power tool, frequently separating or machining, and on account of its use in such a working environment. In addition, damage to or cutting through a cable used for the data transmission can be avoided.

A corresponding positioning method for the afore-described portable power tool is produced from the following details with the advantage that the portable power tool can be handled in a secure, precise and time-saving manner.

In this case, the required position of the portable power tool on a workpiece to be processed is defined via a working mark and is detected by the portable power tool. A deviation of the actual position from the required position is determined and then automatically corrected by the portable power tool or corresponding signals representing the determined deviation are output to a user until said user has eliminated the deviation manually.

In this case images can be recorded by means of the portable power tool and positional deviations from the working mark can be determined by way of the recorded images. In this case each image can be broken down into individual image lines and the deviation from the working mark can be determined by analyzing the image lines.

Once the correct positioning has been obtained and the start instruction given, processing of the workpiece can then be carried out autonomously by the portable power tool.

The portable power tool can be moved perpendicular to the workpiece for the processing of said workpiece. At the same time the deviation from the working mark, in particular the size and direction of the deviation, are visually displayed.

The region of the workpiece in which the determining of the required position can be carried out is marked by means of the portable power tool. In this case, this region can be marked with light, it being possible to mark a preferred displacement direction on the portable power tool in addition to this. A displacement of the portable power tool on the workpiece can be detected here.

The portable power tool is also guided in an indentation or on an edge of the workpiece by way of a mechanical guide element, the mechanical guide element being exchanged in dependence on the workpiece and/or on the processing.

The mechanical guide element is countersinkable in the portable power tool and, when reaching the indentation, is pressed into said indentation by means of spring force. In addition, the portable power tool can be pressed against the workpiece and secured thereto via adhesive elements with rubber or friction linings.

In other method variants the portable power tool is fixed to the workpiece by applying an electromagnetic field or by generating a negative pressure. In this case the negative pressure can be generated by an internal or an external pump that does not belong to the portable power tool.

Over and above this, an overpressure can be generated in a contact region between portable power tool and workpiece and the portable power tool can be displaced on the workpiece on a forming air cushion and/or can be displaced on the workpiece via freely rotating rollers or via rollers driven in a defined manner.

In addition, control instructions for the processing of the workpiece can be transmitted to the portable power tool via a control interface.

### DRAWING

Preferred embodiments of the present invention are described below with reference to the accompanying drawing, in which:

FIG. 1 shows a side view of a hand milling cutter according to the invention,

FIG. 2 shows a view of the milling cutter in FIG. 1 from below,

FIG. 3 shows a perspective view of the milling cutter in FIG. 1, arranged above a working mark,

FIG. 4 shows a bottom view of a sliding block of a milling cutter with rollers according to a second embodiment of the invention, and

FIG. 5 shows a view of a graticule for use as a working mark.

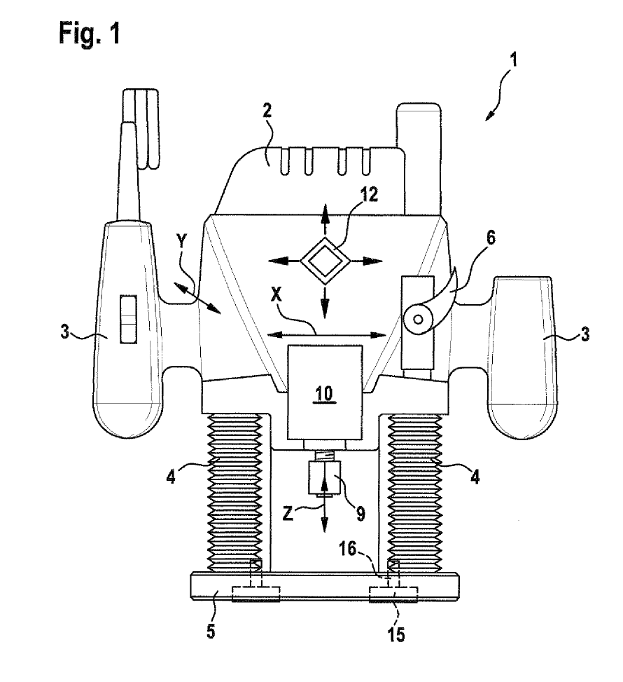

FIG. 1 shows a portable power tool developed as a milling cutter 1 according to a first embodiment of the present invention. The milling cutter 1 includes a basic body 2 with handles 3 provided on the side thereof, two height-adjustable legs which are provided at the side on the underside of the basic body 2, extend downward vertically and are each surrounded by a concertina-type bellows 4, and a circular sliding block 5 provided at the bottom end of the legs. In addition, on the basic body 2 there is a fixing lever 6, via which the legs are lockable in relation to the basic body 2, and a height-adjustable stop member 7, which is securable via a locking screw 8 and defines a movement of the sliding block 5 in the direction of the basic body 2.

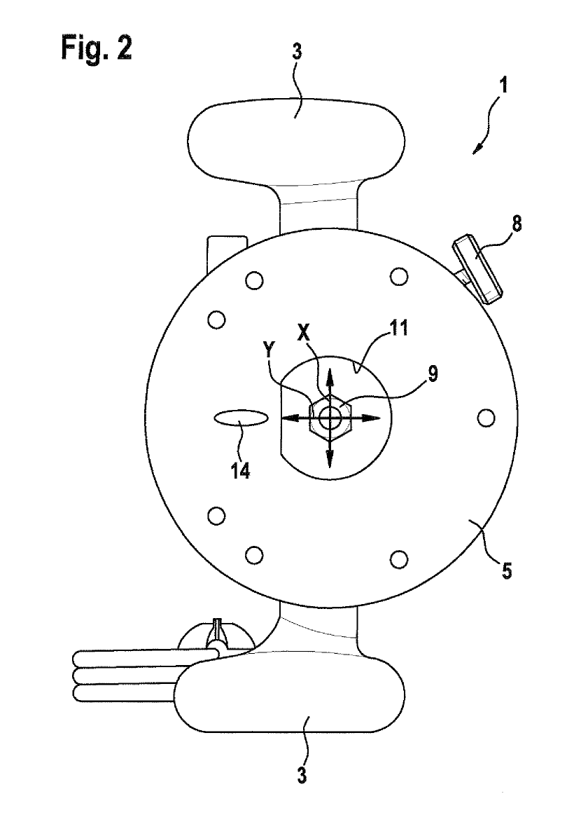

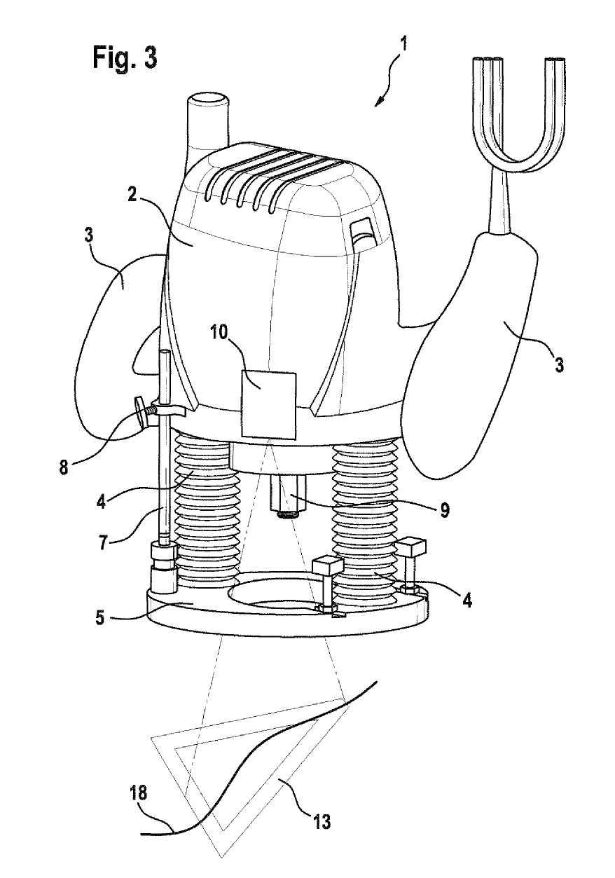

A milling cutter holder 9 for the accommodation of a milling cutter (not shown) is provided on the underside of the basic body 2. The milling cutter holder 9, as can be seen in FIG. 2, is held on the basic body 2 so as to be displaceable along the arrow directions X, Y parallel to the plane of the sliding block 5. In addition, the milling cutter holder 9 is moveable in an arrow direction Z perpendicular to the sliding block 5. Electric servomotors (not shown) are provided for this purpose inside the basic body 2, via which servomotors the respective position of the milling cutter holder 9 is precisely adjustable independently in all three arrow directions X, Y, Z. A camera 10 directed towards the ground is provided as sensor unit on the basic body 2. The camera 10 is realized such that images are detected in a linear manner. An annular lens (not shown in any more detail) is used as a lens in the camera 10.

The camera 10 is aligned such that through a recess 11 in the sliding block 5 it detects the region of a workpiece lying below. A square indicator light 12 is provided on the basic body 2 as the signal output unit, the corners of said square indicator light in each case lying opposite each other in twos in the horizontal or vertical direction, an LED (not shown) which is independently controllable being provided in each corner. The camera 10 is accompanied by an aiming device (not shown in any more detail) which projects a triangular target mark 13 right through the recess 11 of the sliding block onto the workpiece. The triangular target mark 13, in this case, is realized with two interior angles of identical size and one smaller interior angle such that the smaller interior angle at the same time marks a preferred displacement direction on the workpiece. The lateral arrangement of the two handles 3 on the basic body 2 automatically produces the preferred displacement direction from the natural hold of the milling cutter 1 by the user with his two hands held in front of him, such that he pushes the milling cutter 1 away from himself in the registered arrow direction Y.

A control unit (not shown in any more detail) is provided additionally inside the basic body 2, said control unit being connected on its input side to the camera 10. On its output side the control unit is connected to three controlling means that control the positioning of the milling cutter holder 9 in the directions X, Y, Z, and to the display 12. In addition, the control unit is connected to a further controlling means for driving the rotation of the milling cutter holder. The actuation of the controlling means is effected in this case on the basis of the processed camera signals. The control unit is realized as a microcontroller and has an interface for data exchange. The interface is cordless and not visible.

A mechanical guide element in the form of a fin 14 is provided on the underside of the sliding block 5, said fin being held in a resilient manner on the sliding block 5. The resilience is realized such that the fin 14 is moveable in a direction perpendicular to the sliding block 5. The fin 14 is realized longitudinally in the Y direction such that the fin 14 coincides with the preferred displacement direction of the milling cutter 1. The fin 14 is held on the sliding block 5 so as to be exchangeable in order, depending on the milling cutter used, to be able to use a fin 14 with a width that corresponds thereto.

In addition, two rubber elements 15 are provided in the sliding block 5, said rubber elements being held at guides 16. The rubber elements 15 are adjustable perpendicular to the sliding block 5 via the guides 16 and are completely countersinkable therein. The adjusting of the rubber elements 15 is controllable via the control unit.

In principle there are two different possibilities for the operation of the milling cutter 1. First of all the milling cutter 1 can be used as a drill as, on account of the high rotational speeds in particular in soft or fibrous material, the drilled holes are prevented from being torn out compared to drilling with a drill. To this end, a graticule-shaped mark 17 is initially placed on the workpiece at the position of the hole to be drilled. The milling cutter 1 is then positioned on the workpiece and the control unit determines, by way of signals that are transmitted from the camera 10, a deviation of the current actual position of the milling cutter from the mark 17 of the required position. To this end, the image of the camera 10 is evaluated in a linear manner in the control unit and the deviation is determined on the basis of said evaluation. The user is helped here by the target mark 13, by way of which said user is able to bring the mark 17 into the region that is detectable by the camera 10 of the milling cutter 1.

If the mark 17 cannot be detected, the milling cutter 1 outputs this as an error by all four LEDs of the display 12 flashing at the same time. If the mark 17 is detected, but lies outside the adjustment range of the milling cutter holder 9, the direction of the necessary displacement of the milling cutter 1 by the user is signaled via the corresponding LEDs of the display 12. The light intensity of the LEDs corresponds in this case to the distance from the mark 17.

As soon as the mark 17 lies within the adjustment range of the milling cutter holder 9, the LEDs of the display 12 are extinguished and the user can start the processing by depressing a button (not shown). The control unit extends the rubber elements 15 out of the sliding block 5 which means that the milling cutter 1 is no longer displaceable. By way of the image recorded by the camera 10, the position of the mark 17 is now determined precisely and the milling cutter holder 9 is positioned in the plane spanned by the X and Y direction. To this end the servo-drives are actuated by the control unit via the controlling means by way of the calculated deviation. The control unit then controls the milling cutter holder 9 with the milling cutter held thereon in the Z direction perpendicular to the workpiece and at the same time starts the rotating drive of the milling cutter holder 9, such that the desired hole is drilled at the position of the mark 17. The milling cutter is then moved out of the drilled hole by the control unit, the rotating drive is stopped and the rubber elements 15 are countersunk such that the milling cutter 1 is once again on standby for the users and is able to be displaced.

To use milling cutters of different sizes and in particular different lengths, the length of the legs can be adjusted. To this end, the fixing lever 6 is released and the basic body 2 is moved perpendicular to the sliding block 5. The legs are then fixed in their current position by throwing the fixing lever 6. The length of the milling cutter is also taken into consideration via the stop member 7 and drilling too deep is avoided. Thus, by adjusting the stop member 7 the desired drilling depth can be adjusted if this has not already been communicated by means of a parameter of the control unit. The stop member 7 can generate the end signal for processing in the Z direction to the control unit by actuating a switch or electric contact.

Automatic drilling, however, is not limited to drilling one single hole. A plurality of holes can also be drilled into the workpiece in this manner in a certain predetermined arrangement at the site of the mark 17. The user does not have to do anything further for this other than start the drilling operation once and then hold the milling cutter 1 at the position. The control unit executes the drilling of the individual holes automatically one after another as described above.

The second type of operation is the milling of a groove. In this case a linear mark 18 is provided on the workpiece, along which mark the processing is carried out. In this case too the milling cutter 1 is initially aligned approximately, as is necessary for drilling a hole. The control unit is then activated such that it starts the rotating drive of the milling cutter holder 9 and positions the milling cutter holder 9 on the mark line 18. The fixing lever 6 is in its released position which means that the basic body 2 is moveable in relation to the sliding block 5. The stop member 7 is positioned such that the milling cutter can penetrate into the workpiece in order to mill the groove to the desired depth. The target mark 13 specifies the preferred displacement direction in the Y axis to the user such that said user can start the processing along the line 18. As the milling cutter 1 is displaced, an image of the mark 18 is constantly recorded by the camera 10 and the deviation of the current position from the required position defined by the mark 18 is determined by the control unit. The milling cutter holder 9 is controlled in the X direction transversely relative to the displacement direction Y of the milling cutter 1 by way of said deviation. In addition, the deviation is displayed to the user via the display 12 such that said user can compensate for the deviation in a manual manner. In this case too, purely the deviation in the Y direction is displayed in a corresponding manner by means of the two LEDs that lie opposite one another horizontally.

When milling the groove, the fin 14 additionally serves as guide element for the sliding block 5. The fin 14 is initially countersunk in the sliding block 5. When the milling of the groove is started and the groove is already partially formed, the fin 14 springs out of the sliding block 5 and engages in the groove. This means that the milling cutter 1 is additionally stabilized in the displacement direction Y.

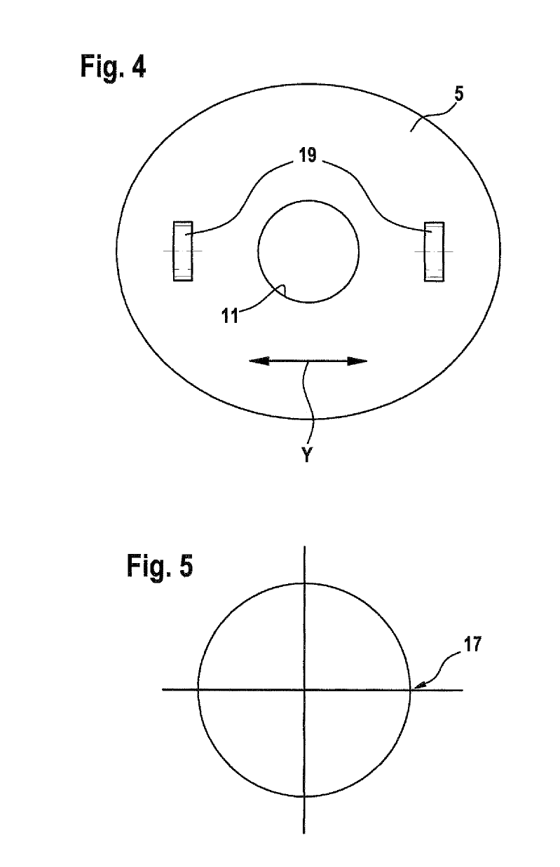

In a second embodiment of the present invention that is shown in FIG. 4, two rollers 19 are provided on the sliding block 5, said rollers extending in the X direction in the plane of the sliding block 5. This means that the sliding block 5 is displaceable in the Y direction on the rollers. The rollers 19 are additionally provided with an electric drive (not shown) that is actuated via the control unit.

The rollers 19 simplify the milling of a groove along a straight line as they prevent a deviation from said line. At the same time, the rollers 19 can be used, in a non-driven mode, to detect the displacement of the milling cutter 1 with the sliding block 5 on the workpiece in the Y direction by detecting the revolutions of the rollers 19. To this end, the display 12 on the milling cutter 1 is expanded such that it additionally indicates the displacement path covered. Thus the user is able to drill holes at fixedly defined intervals along the line without marking each hole individually in a costly manner. This operation can also be carried out automatically, by the control unit driving the rollers 19 in each case in order to cover the desired displacement path along the line. Over and above this, the drilling of the hole can then be started at the desired position directly from the control unit as soon as the milling cutter 1 reaches this position.

The milling cutter 1 can be connected via the interface for data exchange to a laptop, for example, from which the control programs required in each case are transmitted to the milling cutter 1. Consequently, the milling cutter 1 can execute different processing processes within a short period, and also in a simple manner can change from the drilling of holes to the milling of grooves.

1. A portable power tool having comprising:
a sensor unit configured to detect a working mark on a workpiece;
a control unit configured to determine a deviation of an actual position of the portable power tool from a required position based upon a first signal output of the sensor unit: and
at least one of (i) a positioning unit configured to perform an automatic correction of the portable power tool from the actual position to the required position based upon the first signal output, and (ii) a signal output unit configured to output second signals based on the determined deviation to assist a user in performing a manual correction.

2. The portable power tool as claimed in claim 1, wherein the sensor unit includes an optical recognition unit and the control unit includes a microcontroller.

3. The portable power tool as claimed in claim 2, wherein the optical recognition unit records an image in a linear manner, and the control unit determines the deviation based upon the image.

4. The portable power tool as claimed in claim 2, wherein the optical recognition unit includes an annular lens.

5. The portable power tool as claimed in claim 1, wherein the sensor unit is removable from the portable power tool.

6. The portable power tool as claimed in claim 1, wherein the positioning unit includes (i) an actuating drive for each of a plurality of independent positioning directions, and (ii) a corresponding controlling means for each actuating drive.

7. The portable power tool as claimed in claim 1, wherein the signal output unit includes a visual signal output apparatus.

8. The portable power tool as claimed in claim 7, wherein the visual signal output apparatus includes at least one of an LED and a display.

9. The portable power tool as claimed in claim 1, wherein the control unit controls together the positioning unit and a working portion of the portable power tool.

10. The portable power tool as claimed in claim 1, further comprising:
an aiming device configured to project a mark on a region of the workpiece,
wherein the sensor unit is configured to detect the projected mark.

11. The portable power tool as claimed in claim 10, wherein (i) the aiming device includes at least one light element and (ii) the projected mark of is a radiated light from the at least one light element.

12. The portable power tool as claimed in claim 10, wherein the aiming device includes a marking device configured to indicate the preferred direction of displacement of the portable power tool.

13. The portable power tool as claimed in claim 1, wherein the portable power tool has a path detecting apparatus configured to detect a displacement of the portable power tool on the workpiece.

14. The portable power tool as claimed in claim 1, further comprising:
a mechanical guide element configured to engage a groove or channel of the workpiece, or configured to be placed on an edge of the workpiece.

15. The portable power tool as claimed in claim 14, wherein the mechanical guide element is resiliently retractable into the portable power tool.

16. The portable power tool as claimed in claim 14, wherein the mechanical guide element is detachable from the portable power tool.
